(19) United States
(12) Patent Application Publication
(10) Pub. No.: US 2024/0360011 A1
(43) Pub. Date: Oct. 31, 2024

(54) SYSTEM AND METHOD FOR DISINFECTING WATER

(71) Applicant: COPPTER WATER TECHNOLOGIES LTD., Rahat (IL)

(72) Inventors: Oshra SAPHIER, Beer Sheva (IL); Magal SAPHIER, Beer Sheva (IL)

(21) Appl. No.: 18/765,002

(22) Filed: Jul. 5, 2024

Related U.S. Application Data
(63) Continuation-in-part of application No. PCT/IL2023/050025, filed on Jan. 8, 2023.
(60) Provisional application No. 63/297,755, filed on Jan. 9, 2022.

(51) Int. Cl. C02F 1/46

(52) U.S. Cl. CPC C02F 1/4606; C02F 2201/46135; C02F 2201/4618; C02F 2209/02; C02F 2303/04

(57) ABSTRACT

The invention relates to a method of disinfecting water, comprising adding nonindigenous cupric ions to the water and applying voltage across copper-containing electrodes in contact with the water to generate an antimicrobial effect. The nonindigenous cupric ions are supplied to the water from a cation exchange resin charged beforehand with cupric ions. The invention also relates to a disinfection system installable in a body of water, water supply line or in a circulation line of a water flow, for reducing microbial load of the water, by said method.

### FIELD OF THE INVENTION

The invention relates to system and method for disinfecting water with the aid of a copper-based oligodynamic effect.

### BACKGROUND OF THE INVENTION

The antimicrobial effect of copper (Cu) and silver (Ag) is well recognized. Copper is used as a disinfectant in healthcare settings. Silver ions are used to treat wound infection (e.g., burns and/or chronic wounds). In its ionized state Cu is most commonly present as Cu²⁺ (divalent; the cupric ion) rather than as Cu⁺ (monovalent; the cuprous ion). The monovalent ion is the chemically more active and less stable of the two-oxidation states and is easily oxidized in an aqueous environment. However, it is possible to maintain high concentration of Cu⁺ in aqueous solution under certain conditions. For example, by addition of suitable reagents, which form stable complexes with the Cu⁺ cation. Reagents such as acetonitrile (CH₃CN) (Parker A. J, Search, 4, 426, 1973; Parker A. J et al., Journal of Solution Chemistry, November 1981, Volume 10, Issue 11, pp 757-774) or benzoic acid (C₆H₅COOH) (Saphier M et al., J. Chem. Soc., Dalton Trans, 1845-1849, 1999) provide (in anaerobic environment) stable concentrations of cuprous (Cu) ions.

The strong antibacterial activity of the Cu⁺ ion and its potential therapeutic application in the form of topically administrable formulations, e.g., as an ointment, were recently reported in a series of publications [see 1) Magal Saphier, Eldad Silberstein, Yoram Shotland, Stanislav Popov and Oshra Saphier, “Prevalence of Monovalent Copper Over Divalent in Killing Escherichia coli and Staphylococcus aureus”, Current Microbiology 75, p. 426-430 (2018); 2) WO 2018/104937 and 3) Stanislav Popov, Oshra Saphier, Mary Popov, Marina Shenker, Semion Entus, Yoram Shotland and Magal Saphier, “Factors Enhancing the Antibacterial Effect of Monovalent Copper Ions”, Current Microbiology, 77, 361-368 (2020).

Methods exploiting the antimicrobial effect of copper for disinfecting water bodies prone to developing microbial load, such as swimming pools and spa baths, are also known. Such disinfection methods are based on installing copper-containing electrodes in the swimming pool circulation system. With the application of direct current (DC) voltage across the electrodes, antimicrobial effect of the metal is generated (known by the name “oligodynamic effect”), reducing the microbial load in the water supplied to the swimming pool.

Water treatment technologies based on the oligodynamic effect may therefore be considered as replacement for conventional methods that require the addition of chemicals such as chlorine and bromine to the water.

For example, U.S. Pat. No. 4,525,272 describes water purification by an electrolytic cell in which copper and iron electrodes are mounted. The current flow between the electrodes causes the copper electrode to produce a concentration of copper ions in the water, which kill the algae and bacteria in the water. For purification of swimming pools, the electrolytic cell is usually operated at a voltage of 0.5 to 6.0 V.

EP 467831 relates to the purification of water, specifically swimming pools, with the aid of a pair of copper electrodes. The water moves through the space between an outer, cylindrically-shaped copper electrode surrounding an inner copper electrode, in the form of a rod or a tube. It is reported that a useful DC voltage is from 6 to 10 V.

DE 2619725 describes a method for disinfecting a swimming pool by the effect generated by a pair of copper electrodes mounted in a swimming pool circulation system and supplied with DC voltage in the range from 0 to 15V.

EP 3012231 is about a method for treating the water of a swimming pool with copper/silver-based electrolysis device, that supplies copper/silver ions to the water under the application of DC voltage (˜4 to 5V).

WO 2020/037021 relates to a method of disinfecting water by application of voltage across a pair of electrodes consisting of an outer, tubular-shaped copper electrode, and an inner, coaxially aligned copper electrode in the form of a copper wire, with water moving through the internal space defined by the outer electrode. An exemplary DC voltage applied in the tests reported in WO 2020/037021 is 1.5 V.

### THE INVENTION

It was found that application of low DC voltage (˜0.15 to 0.45V, ˜0.2 to 0.4V, e.g., 0.25 to 0.37V) across a pair of copper-based electrodes in contact with water, in conjunction with controlled addition of nonindigenous Cu²⁺ ions to the water (by “nonindigenous” we mean Cu²⁺ supplied from an external source, i.e., not an electrolytically-generated Cu²⁺), shows a strong antimicrobial effect, achieving significant reduction, and even eradication, of microorganisms (bacteria, fungi, viruses) in the water.

Because the strong antimicrobial effect was observed with Cu⁽⁰⁾ electrodes, over a narrow voltage window, and only in the presence of nonindigenous Cu²⁺ in the water, it is hypothesized that with an electric potential of ˜0.3 V across the electrodes, an in-situ production of cuprous (Cu⁺) ion occurs. Namely, by one electron reduction of the Cu²⁺ ion to give Cu⁺, and one electron oxidation of metallic copper to give Cu⁺:

| | | |
|---|---|---|
| Cu⁺² + e → Cu⁺ | E⁰ = +0.159 V | (cathode reaction) |
| Cu⁰ → Cu⁺ + e | E⁰ = −0.52 V | (anode reaction) |
| Cu⁺² + Cu⁽⁰⁾ → 2 Cu⁺ | E⁰ = −0.36 V. | |

Normally the anodic reaction yields divalent copper, but under the conditions listed above, a high percentage (>50%, >70%) of monovalent copper ions may be obtained. An electrolytically generated Cu⁺, owing to its potent antimicrobial action, could account for the reduced microbial load in the water.

The invention therefore primarily relates to a method of water disinfection, comprising adding nonindigenous Cu²⁺ ions to the water and applying voltage across copper-containing electrodes in contact with the water to generate an antimicrobial effect, e.g., a bactericidal effect. Low DC voltage is applied; less than 0.5 V; from 0.1 to 0.5V, from 0.15 to 0.45V, e.g., 0.2 to 0.4 V; 0.25 to 0.37 V.

A constant supply of low concentration of nonindigenous Cu²⁺ ions to the water (preferably in the range from 0.05 to 1 ppm, e.g., 0.1 to 0.25 ppm) can be achieved with the aid of a cation exchange resin charged beforehand with Cu²⁺ ions. Suitable cation exchange resin for use in the invention binds Cu²⁺ selectively at nearly neutral pH (6-8), such that with the passage of water, cations in the water displace only a tiny fraction of the tightly bound Cu²⁺ ions from the resin, to be available in the vicinity of the copper-containing electrodes/for the electrochemical reactions occurring at the copper-containing electrodes.

Another aspect of the invention is a disinfection system installable in a water body, a water supply line or in a circulation line of a water flow, for reducing microbial load of the water, wherein the disinfection system has an inlet and an outlet for a water flow, said disinfection system comprising Cu²⁺-loadable cation exchange resin and copper-containing electrodes electrically connected to a DC power supply, and optionally a control unit (e.g., with a pH electrode, a redox electrode, a conductivity meter, a turbidity meter and a temperature meter).

Cation exchange resins showing high selectivity towards Cu²⁺ that are useful in the present invention are chelate resins, e.g., resins possessing functional groups that can form coordination complexes with Cu²⁺ in a selective manner, e.g., with selectivity towards Cu²⁺ compared to Ca²⁺. Suitable functional groups contain nitrogen and/or oxygen and/or sulfur atoms; for example, an aminophosphonic acid group R—CH₂—HN—CH₂—P(O)(OM)₂ (where M is H or a monovalent metal cation displaceable by Cu²⁺, such as sodium), a sulfonic acid group, an iminodiacetic acid group and a thiourea group. Suitable resins are usually based on styrene-divinylbenzene copolymer matrix functionalized with the above mentioned groups, especially aminophosphonic groups, e.g., in the sodium form (M-Na). Cation exchange chelate resins are available on the marketplace in the form of e.g., spherical beads with sizes in the range from 0.1 to 1.5 mm, with a total exchange capacity of at least 10 eq/L, e.g., at least 25 eq/L. The experimental work reported below indicates that good results were obtained with an aminophosphonic acid chelating resin, such as Purolite S940. Aminophosphonic acid chelating resin can also be prepared by synthetic methods described in the art, such as those found in EP 65120. Other types of commercially available chelate resins include AMBERSEP M4195 from DUPONT.

To determine if a chelate resin shows sufficient selectivity for Cu²⁺, a simple test may be conducted. An aqueous solution that contains Cu²⁺ and a competitor cation, e.g., Ca²⁺ (Cu²⁺/Ca²⁺ molar fraction of 0.5/0.5), is contacted with the resin at a dosage of 1 ml resin per 50 ml solution. The resin particles are stirred or shaken in the solution. After separation by filtration or decantation, the concentrations of the metals in the solution are measured, e.g., by ICP (inductive coupling plasma). Decrease in the Cu²⁺ molar fraction, and respective increase in the Ca²⁺ molar fraction, say, of 10% or more, indicates that the resin under consideration has acceptable selectivity towards Cu²⁺.

To load a commercial chelate resin with Cu²⁺ ions, such that it can be used as a source of Cu²⁺ in the invention, a resin (e.g., in the sodium form) is treated for 30-120 minutes with an aqueous solution of Cu²⁺ salt at a concentration of 0.1-1 M, at a dosage (volume of resin to volume of aqueous solution) of about 0.5-1 liter resin per 1 liter solution, whereby the Cu²⁺ is captured by the resin, e.g., to obtain a suitable Cu²⁺-loaded cation exchange resin with 30-60 mg Cu²⁺ per gram resin. The loading is carried out in a stirred vessel or in a column.

It is often most convenient to place the Cu²⁺-loaded cation exchange resin upstream to the copper-containing electrodes. When a water stream to be treated flows through a column packed with such Cu²⁺-loaded cation exchange resin, the effluent discharged from the column carries acceptably low, yet effective, amount of Cu²⁺ ions. The Cu²⁺-added water stream then moves through the space between the copper-containing electrodes, across which a low voltage is applied, whereby the water is disinfected (e.g., by the in-situ generation of the potent disinfectant cuprous ion; thus the method of the invention also relates to the in-situ generation cuprous (Cu⁺) ions in the water (e.g., up to ˜2 ppm, e.g., up to 0.5 ppm). Data summarized in Table 1 shows typical chemical composition of water treated by the method of the invention. The results suggest that 0.2±0.05 ppm of monovalent copper ions is sufficient for disinfection of water.

TABLE 1

| Temp | Cu ions | TN (total | TOC | Conductivity | |
|---|---|---|---|---|---|
| (° C.) | (ppm) | nitrogen) (ppm) | (ppm) | (μS/cm) | pH |
| 20 | 0.20 ± 0.05 | 0.54 ± 0.01 | 6.30 ± 0.19 | 283 ± 3.54 | 7.62 ± 0.01 |
| 25 | | 0.43 ± 0.02 | 6.10 ± 0.01 | 290 ± 7.78 | 8.04 ± 0.01 |
| 30 | | 0.29 ± 0.03 | 6.48 ± 1.04 | 253 ± 3.54 | 8.40 ± 0.01 |
| The standard | 1.3 (USA) | 10 | 25 | 500-1000 | 7.5-8.5 |
| drinking water | 2 (Europe) | | | | |
| [*] | | | | | |

[*]National Primary Drinking Water Regulations, Ground Water and Drinking Water. EPA. 2019 Sep. 17.
https://www.epa.gov/ground-water-and-drinking-water/national-primary-drinking-water-regulations, 2019.

Copper-containing electrodes for use in the invention include pure copper (e.g., copper foams); and alloys consisting primarily of copper, e.g., not less than 75% metallic copper, e.g., >85%, >90% Cu (by weight), and one or more secondary metals selected from the group consisting of tin (e.g., from 1 to 15% Sn, ˜ 5 to 10% Sn, usually around 7-8% Sn) and silver (e.g., from 1 to 15% Ag, ˜5 to 10 Ag, usually around 7-8% Ag). Application of e.g., 0.2 to 0.4 V potential difference across bronze electrodes consisting of Cu—Sn 85-95%/5-15% alloy, e.g., 90-95/5-10 alloy (especially sintered bronze) was shown to give effective bactericidal action in a flow of Cu²⁺-added water moving through the space between the bronze electrodes.

Regarding structure, geometry and morphology of the electrodes, experimental work reported below indicates that good results are achieved with the aid of sintered bronze electrodes with the composition specified in the immediately preceding paragraph. Sintered bronze electrodes have high porosity (pore diameter ˜5-500 μm) and they can be prepared by mixing copper and tin powders, melting the mixture, allowing the melt to solidify, crushing and milling to obtain 40 to 400 μm sized spherical particles (e.g., ˜200 μm grains), pressing in a mold and sintering to attain a final shape, i.e., tube-shaped porous bronze composed of the grains with a diameter mentioned above (benefits received from cylindrically-shaped, sintered bronze electrodes (hollow tubes) are shown below). Other forms, e.g., (pure copper foam and cast bronze) also show strong bactericidal action when aided by the supply of Cu²⁺ under the application of ˜0.3 V, but bacteria removal rates are somewhat slower compared to removal rates achieved with sintered bronze. For example, the time it takes to get 1 log reduction (90% reduction) of bacteria population with copper foam electrodes, is fivefold or sixfold longer. Thus, bronze electrodes are especially suited to treatment programs requiring rapid action.

In some exemplary embodiments of the invention, the system is deployed in water and/or wastewater for disinfection. The invention is well suited for the treatment of (man-made) bodies of water where standing water requires purification, such as pools (e.g., swimming pool and ponds), spa baths and hot tubs. Drinking water dispensers and water supply systems for agricultural use (irrigation systems) can also benefit from the invention. That is, for the treatment and secure of safe water for drinking and agriculture without the addition active chlorine or other oxidizers; and for disinfecting wastewater without using active chlorine or other oxidizers.

FIGS. 1A and 1B show a water disinfection treatment based on the process design described above, i.e., with a pair of copper-containing electrodes installed downstream to Cu²⁺-loaded cation exchange chelate resin, according to a first embodiment of the invention. Bodies of water such as swimming pools have circulation systems, into which a disinfection system of the invention, accommodating the cation exchange resin and the copper-containing electrodes, can be incorporated. With reference to FIGS. 1A and 1B, water stream (1) leaves the pool (2), impelled by a pump (3) through a filter (4) and then back to the pool via a return line connected the pool inlet (the disinfection system may optionally comprise a pump of its own). The disinfection system (5) according to the invention is installed in the circulation line (6), e.g., downstream to the pool filter (4), as shown in FIG. 1B. A heater (not shown) is usually placed downstream to the filter. The process design shown in FIGS. 1A and 1B is based on a single disinfection system, but in some cases a series of systems can be used.

According to the first embodiment, the disinfection system (5) consists of two subunits: a packed bed of Cu²⁺-loaded cation exchange resin (15) in the first subunit (5A) and an electrolytic cell (5B) in the second subunit. The two subunits are joined by a water flow line (7). Subunits (5A) and (5B) can be mounted in a single housing, having an inlet and outlet openings for a water flow.

For example, subunit (5A) may include a pipe filled with the Cu²⁺-loaded cation exchange resin (15), i.e., a standard column design; or the packed bed may be provided in other vessels, such within a conventional water filter housing (both designs are hereinafter sometimes referred to as “IEX column”). Pump (3) pushes a water stream from the pool to move into (labeled IN→) and through the IEX column (5A). For example, to disinfect 2-50 m³ swimming pool, equipped with a pump supplying flow rates of 0.4 to 10 m³/hour, the IEX column is provided with 0.1 to 1 liter bed volume. The outgoing water, i.e., the effluent stream (labeled →OUT), is directed the electrolytic cell (5B) via water line (7).

Accordingly, in one embodiment of the invention, the disinfection system comprises a first subunit and a second subunit, with a packed bed of Cu²⁺-loadable cation exchange resin positioned in the first subunit and copper-containing electrodes in the second subunit, wherein the subunits are joined (e.g., by a duct) to allow water flow such that on installation in a water supply line or in circulation line of a water flow, the first subunit is installed upstream to the second subunit.

Turning now to the electrolytic cell, the copper-containing electrodes for use in the invention may be of different shapes and geometries. For example, the electrolytic cell may possess an axial symmetry, e.g., with electrodes assembled as nested electrodes in cylindrical configuration. Namely, an outer, cylindrically-shaped electrode provided by a lateral surface of a cylinder, encircling an inner electrode in the form of wire, rod, or hollow tube of smaller diameter. The outer and inner electrodes are coaxially aligned; water is directed to flow through the annular space located between the outer and inner electrode.

The process design shown in FIGS. 1A, 1B and 1C constitutes a preferred embodiment of the invention. It is based on nested, sintered, porous, bronze-made electrodes assembled in cylindrical configuration, with an inner electrode consisting of a hollow tube. With reference to FIG. 1C, the outer (8) and inner (9) electrodes are of comparable length. The electrodes assembly has front and rear sides (10, 11); the incoming water stream supplied from the IEX subunit to the electrolytic cell through water line (7), enters the electrodes assembly in (53) through the front side (10) (which is the top side, when the electrode assembly is vertically positioned). The rear side (11) of the electrode assembly, i.e., the base of the outer electrode (8), is preferably sealed. The water line (7) is fitted into the interior of the inner electrode (9). The electrodes are connected to a DC voltage source (13).

In operation, water stream (7) is impelled by a pump to move into the internal space of the inner electrode (9); the incoming flow into the interior of electrode (9) is labeled IN→ in FIG. 1C.

Owing to the porosity of sintered bronze, the water is pushed to flow across the walls of the inner electrode (9), e.g., in radial direction, as indicated by the left arrow, reaching the annular space (12) located between the cylindrically-shaped electrodes 8 and 9. The outgoing water stream (labeled OUT→) exits the annular space (12) back to the circulation line.

Experimental results reported show that a strong bactericidal effect is achieved with the aid of the design described above. It is hypothesized that the path of water flow created by the design shown in FIG. 1C, whereby the Cu²⁺-added water stream produced by the IEX unit moves across porous bronze, increases the exposure of cupric ions to the high surface area bronze grains.

Accordingly, the invention specifically relates to a disinfection system, comprising a first subunit and a second subunit, with the packed bed of Cu²⁺-loadable cation exchange resin positioned in the first subunit and the copper-containing electrodes in the second subunit, wherein the copper-containing electrodes are sintered bronze electrodes assembled with cylindrical configuration, consisting of an outer electrode provided by a lateral surface of a cylinder encircling an inner electrode in the form of a hollow tube, with an annular space located between the electrodes, wherein the electrodes assembly has a front side facing the first subunit and an opposite rear side, wherein the rear side of the electrodes assembly is preferably sealed, such that on installation, water stream that exits the first subunit is directed to flow into the second subunit to enter the interior of the inner electrode, and wherein the water outlet opening of the disinfection system is in fluid communication with the annular space located between the electrodes.

The invention accordingly also relates to a method comprising impelling water by a pump to flow in a water supply line or in water circulation line connected to a packed bed of Cu²⁺-loaded ion exchange resin positioned upstream to the electrodes assembly, wherein the electrodes assembly consists of an outer electrode in the form of a lateral surface of a cylinder encircling an inner electrode in the form of a hollow tube, wherein the electrodes are made of sintered Cu—Sn, wherein the electrodes assembly has a front (upstream) side for receiving an incoming water stream and a rear side, wherein the rear side of the electrodes assembly is preferably sealed, such that Cu²⁺-added water released from the ion exchange resin moves to the interior of the inner electrode and flows through the porosity of the wall of the inner electrode (that is made of sintered bronze) into an annular space located between the outer and inner electrodes, and from the annular space, to the water supply line or the water circulation line.

For example, to purify 2-50 m³ swimming pool as described in reference to FIGS. 1A, 1B and 1C, using cylindrical electrodes nested one within the other, 5-25 cm long copper-containing electrodes (the outer and inner electrodes are of comparable length) are used. The outer diameter (d₁) of the outer electrode is 50 mm≤d₁≤100 cm and its inner diameter (d₂) is at least 1 mm smaller than the outer diameter d₁, e.g., d₂ is about 2 to 5 mm smaller than d₁. The outer diameter (da) of the internally placed electrode is adjusted to provide an annular space with ring diameter 2 to 20 mm (2 mm<d₁−d₃<20 mm, for example, 2 mm<d₁−d₃<10 mm, e.g., ˜5 mm ring diameter).

Turning now to the control unit (14) shown in FIG. 1B, the control system may be connected by a subsidiary pipe (not shown), that diverges from the water circulation line of the pool, such that several properties of the water can be measured continuously, or at regular time intervals. Properties of interest, that are measured by the control unit to serve as indicators for a satisfactory operation of the treatment, include:
pH (measured by pH electrode; acceptable range is from 6.5 to 7.8);
redox potential (measured by redox electrode; acceptable range is from 280 to 350 mV vs. Ag/AgCl);
water conductivity (measured by conductivity meter; acceptable range is from 0.5 to 1.5 mS);
turbidity (measured by turbidity meter; acceptable range is from 0.8 to 1.1 NTU);
flow rate (determined/measured by flow meter; acceptable range is from 300 to 700 liter/h); and
temperature (measured by temperature meter; acceptable range is from 20 to 40° C.; 20 to 30° C.).

The voltage applied across the electrodes may be monitored by the control unit (˜0.2-0.4 V, ˜0.25-0.37 V).

As an alternative to the electrolytic cell with cylindrical symmetry that was shown in FIGS. 1A, 1B and 1C, it is possible to use an electrolytic cell consisting of a pair of planar (flat) electrodes positioned in parallel to one another. As shown schematically in FIG. 2, the electrolytic cell (5B) is placed downstream to ion exchanger (5A). The two electrodes (8,9) have opposed, spaced apart faces that define a water passage through which water flows. The distance between the electrodes is from 2 mm to 20 mm, e.g., from 2 mm to 10 mm. This design is suitable for disinfection of small volumes of water; electrodes are usually identical in shape (e.g., polygonal such as square or rectangular electrodes) and size (with effective electrode area of about 0.2 to 1 m per 1 m³ water). In the embodiment depicted in FIG. 2, two metallic copper electrodes (brown rectangle) have a potential difference 0.2 to 0.4 V (0.3 V is depicted) applied to them. This causes one electron reduction of metallic copper to monovalent copper ions Cu⁰→Cu⁺. In addition, water flowing in (as indicated by arrow) releases divalent cupric ions from ion exchange resin 5A (depicted as a blue block). These divalent copper ions pass between the electrodes where the applied voltage causes reduction of divalent copper ions Cu²⁺→Cu⁺. As a result, the concentration of monovalent copper ions in the water is increased.

The deployment of the cation exchange resin separately from, and upstream to, the electrolytic cell is one way to achieve a strong antimicrobial effect. High antimicrobial activity can also be obtained when the packed bed consisting of Cu²⁺-loadable ion exchange resin is placed in the interior of a flow-through, cylindrically shaped electrode, as shown in two different configurations depicted in FIGS. 3 and 4.

FIG. 3 is a simplified schematic representation of a water treatment system wherein the electrodes are cylindrical and nested one within the other (8,9), with the ion exchange resin (15) positioned inside the cylinder defining the inner electrode (9) (in FIG. 3, the inner electrode extends from the outer electrode for the purpose of illustration; in some variants the inner electrode consists of two symmetrical resin-filled parts, like (9), that are joined together; their total length corresponds to the length of the outer electrode (8)). The outer and inner electrodes (8,9) are preferably sintered porous Cu—Sn electrodes as previously described. Cylindrically-shaped sintered bronze electrodes with high porosity fit well into such design, because water stream directed to move through the Cu²⁺-loaded ion exchange resin (15) in the interior of the inner electrode (9) is impelled by a pump to flow through the porous wall, into the annular space located between the electrodes.

Thus, the invention also provides a method based on the design of FIG. 3, wherein the electrodes assembly consists of an outer electrode in the form of a lateral surface of a cylinder encircling an inner electrode in the form of a hollow tube, wherein at least the inner electrode, or both, are made of sintered Cu—Sn, wherein the electrodes assembly has a front side for receiving an incoming water stream and a rear side, wherein the rear side of the electrodes assembly is preferably sealed, with the ion exchange resin filling the interior of the inner electrode, wherein the method comprises impelling water by a pump to flow in a water supply line or in water circulation and move into the interior of the inner electrode, such that Cu²⁺-added water released from the ion exchange resin flows from the interior space of the inner electrode through the porosity of the wall of the inner electrode into an annular space located between the outer and inner electrodes, and from the annular space to the water supply line or the water circulation line.

A disinfection system based on the design shown in FIG. 3 forms another aspect of the invention. That is, a disinfection system wherein the copper-containing electrodes are sintered bronze electrodes assembled with cylindrical configuration, consisting of an outer electrode provided by a lateral surface of a cylinder encircling an inner electrode in the form of a hollow tube, with an annular space located between the electrodes, wherein the electrodes assembly has a front side facing the water inlet opening of the disinfection system and an opposite rear side, wherein the rear side of the electrodes assembly is preferably sealed, with the ion exchange resin occupying the interior of said inner electrode.

FIG. 4A (side view) and 4B (top view) show another process design in which a packed bed consisting of Cu²⁺-loadable ion exchange resin is placed in the interior of flow-through, cylindrically-shaped electrodes. Incoming water stream (e.g., wastewater, gray water, drinking water) that enters pipe (31) is labeled in “IN↓”. An array consisting of 2n electrodes (n is an integer number, usually from 1 to 5) made of sintered bronze are installed in the pipe, such that their longitudinal axis is parallel to the longitudinal axis of the pipe. The array of 2n electrodes is equally divided into n anodes and n cathodes. For example, in the top view of the installation depicted in FIG. 4B, n−2 such that the total number of electrodes equals 4. The electrodes are labeled An1, An2 (positive electrodes, anodes) and Ct1, Ct2 (negative electrodes, cathodes). The geometry of the array is such that adjacent electrodes are of opposite polarity (for example, if the electrodes are positioned to create a square shape, like in FIG. 4B, then electrodes in opposite vertices are of the same sign). The electrodes are installed with the aid of water impermeable partition (33) mounted in the internal space (32) of the pipe (31), perpendicularly to the longitudinal axis of the pipe, e.g., the partition is perforated with holes through which the electrodes are passed and are tightly held in place.

Incoming water stream is impelled to flow through the walls of the electrodes, made of porous sintered bronze as explained above, thereby steadily supplying Cu²⁺ ions to the water exposed to the voltage difference applied across the bronze electrodes. The outgoing, disinfected water stream is labeled “↓OUT”.

Regarding temperature effect, experimental results reported below show that the efficiency of the treatment increases with increasing temperature. For example, in a lab-scale experiment, at 20° C., effective disinfection required 20-30 minutes. At 30° C. and 40° C., effective disinfection required 4-10 minutes. This data demonstrates that the invention is useful in swimming pools and spa facilities (heated pools). Accordingly, another aspect of the invention involves a method of water disinfection as described herein, wherein the temperature of the water is not less than 20° C., e.g., >30° C., e.g., between 25 and 40° C. Spa water temperature often lies in that range. The disinfection system may optionally include a heater, e.g., an electrical heater.

Regarding pH effect, pool water pH is usually kept in the range between 7 and 8, e.g., between 7.2 and 7.8. Experimental work conducted in support of this invention shows that the treatment is more efficient over a slightly acidic pH (6-7). However, a potent antimicrobial effect is also measured when the pH of the water is from 7.2 to 7.8, as time taken to eradicate bacteria population in the water (i.e., reach “zero germs”) over that pH range is comparable to a conventional turnover rate (the time it takes for all water in the pool to be circulated through the pump/filter system). That is, conventional water pool circulation programs, i.e., with turnover rates in the range from 12 hours to 3 hours, enable the treatment of the invention to reach 3, 4, 5 log reduction and even eradication of bacteria (“zero germs”). The disinfection system may optionally include a tank for holding hydrochloric acid and a metered pump to supply metered amount of the acid if pH adjustment is needed.

From time to time, e.g., at fixed time intervals, say, every 1-60 minutes, e.g., from 5 to 15 minutes, it is useful to reverse the polarity of the potential difference across the electrodes, to suppress deposition and plating of various copper forms onto the cathode. Reversal of polarity prolongs the service time of the electrodes mounted in the cell, avoiding frequent replacement of exhausted electrodes with fresh electrodes.

FIG. 5 shows a scheme of an electrical circuitry and related devices that can be used to reverse the polarity of the electrodes at regular time intervals. The polarity reverser (41) performs a change of the polarity of the electrodes (8,9) according to time intervals set by timer (42), for example, every ten minutes. Each electrode (8,9) can switch between two states, labeled (A1) and (A2), indicating that an electrode is connected to the negative pole and positive pole, respectively. Two switches (15 [symbol] ) are situated in junctions, closing/opening circuits (16) and (18). In the scheme depicted in FIG. 5, electrode (8) is at state (A1) (negative electrode; cathode) and electrode (9) is at state (A2) (positive electrode; anode), as determined by the positions of two switches (15 [symbol] ), which close electrical circuit (16). Polarity reversal is carried out by controlling switches (15 [symbol] ), such that they simultaneously disconnect electrical circuit (16) and close electrical circuit (18). The positive electrode becomes negative and vice versa.

One aspect of the invention is concerned with in situ production system of cuprous ion by the reduction of cupric (bivalent copper ion, Cu²⁺) and oxidation of metallic copper using electric potential of 0.3 V (0.2 to 0.4V) with cation exchange resin charged with cupric ions (e.g., aminophosphonic chelating resin) as a source for cupric ions and as a mean of control the concentration of copper ions in the water; for treatment and secure safe water for bathing in swimming pools and spa complexes without active chlorine or other oxidizing agents.

Apart from the Escherichia coli bacteria, the method according to the invention was successfully tested on: Staphylococcus aureus, Bacillus thuringiensis, Enterobacteraerogenes, Micrococcus luteus, Staphylococcus epidermidis, Streptococcus faecalis, Pseudomonas aeruginosa, Delftiatsuruhatensis, Staphylococcus cohnii, Brevibacillusbrevi, Cyanobacteria, Brewer's yeast and Baking yeast. The method of the invention is especially effective in killing/preventing the growth of gram negative bacteria.

As explained above, the application of low electric voltage (˜e.g., 0.3 V) across copper electrodes with concomitant supply of nonindigenous Cu²⁺ ions to the treated water, resulted in killing and eradication of bacteria, by in-situ generation of cuprous ions. At lower electric potential (<0.1V) the desired electrochemical reactions will not occur, and in higher electric potential (>0.5V) the electrochemical process generates Cu²⁺ ions at the cathode and OH⁻ at the anode.

### In the Drawings

FIGS. 1A and 1B show the incorporation of a disinfection system of the invention into water circulation line of a swimming pool, with the ion exchange resin column positioned upstream to an electrolytic cell with an outer, cylindrically-shaped electrode, surrounding an inner, tubular electrode. FIG. 1C shows the flow path of the water through the electrolytic cell.

FIG. 2 shows a disinfection system of the invention, with the ion exchanger positioned upstream to an electrolytic cell that is based on planar electrodes.

FIG. 3 shows a disinfection system of the invention, with an electrolytic cell based on an outer, cylindrically-shaped electrode, surrounding an inner, tubular electrode, with the IEX resin filling the interior space of the tubular electrode.

FIGS. 4A and 4B are side and top views, respectively, of disinfection system installed in a pipe; the cylindrical electrodes are filled with the IEX resin.

FIG. 5 shows an electrical circuitry which enables reversal of electrodes polarity.

FIG. 6 is a bar diagram showing Log CFU/ml of E. Coli bacteria as a function of potential difference applied across copper electrodes, i.e., the results of the experiment reported in Example 1.

FIG. 7 is a 3D histogram showing Log CFU/ml of E. Coli bacteria as a function of treatment time and temperature, for the experiment reported in Example 1.

FIG. 8 is a photograph showing an experimental set-up used in the experiment reported in Example 2.

FIG. 9 is a bar diagram showing Log CFU/ml of E. Coli bacteria as a function of potential difference applied across copper electrodes, i.e., the results of the experiment of Example 2.

FIG. 10 shows the design of a large-scale experiment, with IEX and electrolytic cell integrated in a water circulation line of 2000 liter pool, reported in Example 3.

FIG. 11 shows the installation of nested electrodes (made of sintered bronze) with cylindrical configuration in a water filter housing, used in the experiment reported in Example 3.

FIG. 12 shows bacterial counts versus time plot based on the large-scale experiment reported in Example 3.

FIG. 13 is a bar diagram showing turnover rates and time taken to eradicate bacteria based on the large-scale experiment reported in Example 3.

FIG. 14 is a plot showing the time taken to eradicate bacteria versus pH variation across the nearly neutral pH range based on the large-scale experiment reported in Example 3.

FIG. 15 is a plot of bacterial counts (CFU/ml of E. Coli bacteria) versus time over a period of four months, based on the large-scale experiment reported in Example 3.

FIG. 16 schematically illustrates a cross-section of a unified, cylindrically shaped disinfecting apparatus 100, according to a second embodiment of the invention.

FIG. 17A shows a general perspective view of the apparatus, according to the second embodiment of the invention.

FIG. 17B shows the internal structure of the apparatus, according to the second embodiment of the invention.

FIG. 17C generally shows the top casing part of the apparatus, according to the second embodiment of the invention.

FIG. 17D generally shows the bottom casing part of the apparatus, according to the second embodiment of the invention.

FIG. 17E is a bottom view of the top casing part of the apparatus, according to the second embodiment of the invention.

FIG. 17F is a bottom view of the bottom casing part of the apparatus, according to the second embodiment of the invention.

FIG. 17G shows a general perspective view of the apparatus, while the bottom casing part is removed, according to the second embodiment of the invention.

FIG. 17H shows a general bottom-perspective view of the apparatus, while the bottom casing part is removed, according to the second embodiment of the invention.

FIG. 17I shows a general perspective view of the apparatus, while the bottom casing part, including the wiring, is removed, according to the second embodiment of the invention.

FIG. 17J shows a general perspective view of one electrodes unit, according to the second embodiment of the invention.

### EXAMPLES

### Preparation 1

Selectivity test for a cation exchange resin (sodium form) towards Cu²⁺/Ca²⁺

The following procedure was used to determine whether a chelate resin (aminophosphonic chelating resin) shows sufficient selectivity for Cu²⁺. The procedure may be used to test other resins.

Aminophosphonic chelating resin (10 g of Purolite S940, in the sodium form) was placed in an Erlenmeyer flask of 250 ml. Cu²⁺/Ca²⁺ solution, proportioned 0.5/0.5 (molar fraction) was prepared by dissolving respective amounts of CuCl₂·2H₂O and CaCl₂)·2H₂O in distilled water (0.05M=[Cu²⁺]=[Ca²⁺]; the total volume was made up to 100 ml).

Cu²⁺/Ca²⁺ solution (100 ml) was added to the resin in the Erlenmeyer flask and was shaken for 1-12 hours. The solution was separated by decantation (without disturbing the resin particles). A sample was taken to measure the concentration of copper and calcium in the solution that was removed from the Erlenmeyer flask. The molar ratio Cu²⁺/Ca²⁺ in the solution was determined by ICP and was found to be 0.4/0.6, indicating high selectivity of the resin towards cupric ions in the presence of calcium ions.

### Preparation 2

Charging Cation Exchange Resin (Sodium Form) with Cupric Ions

The following procedure was carried out to give 200 g of Cu²⁺-loaded chelate resin that can be used in the invention.

CuSO₄·5H₂O (100 g) was dissolved in distilled water and the total volume made up to 1000 ml. Aminophosphonic chelating resin (200 g of Purolite S940, in the sodium form) was placed in an Erlenmeyer flask. Cu²⁺ solution (100 ml) was added to the resin in the Erlenmeyer flask and was shaken for ten minutes. The solution was separated by decantation (without disturbing the resin particles). A sample was taken to measure the concentration of copper in the solution that was removed from the Erlenmeyer flask. The steps consisting of 1) addition of Cu²⁺ solution (100 ml) to the resin in the Erlenmeyer flask, 2) shaking the solution for ten minutes, 3) decantation and 4) measurement of Cu²⁺ is the solution separated from the flask were conducted four times. In the fourth time, the solution was shaken for twelve hours. Lastly, the resin was washed with distilled water (500 ml).

### Example 1

Water Disinfection Using Nested Copper Electrodes in Cylindrical Configuration with Voltage Applied Across the Electrodes and Addition of Cu²⁺ from IEX to the Water

### Materials and Methods

A cation exchange resin (aminophosphonic chelating resin Purolite S940) loaded with Cu²⁺ served as a source of divalent copper ions. Before assembling in the instillation, the resin was loaded with Cu²⁺ cation using an aqueous solution of CuSO₄. Once installed in the system, a flow of water to be treated passing through the loaded cation exchange releases some Cu²⁺ ions by exchanging with dissolved cations (e.g., Na+) present in the water. In a circulated water stream, the cation exchange resin keeps an acceptably low, fairly constant copper ion concentration in the water such that it does not exceed a threshold value set by regulations (according to the specification of the treated system).

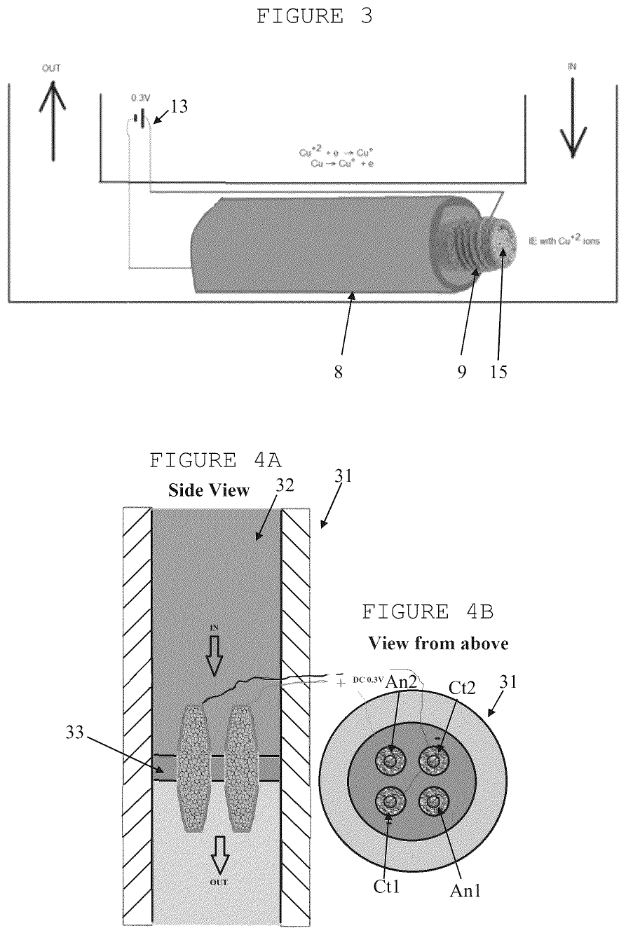

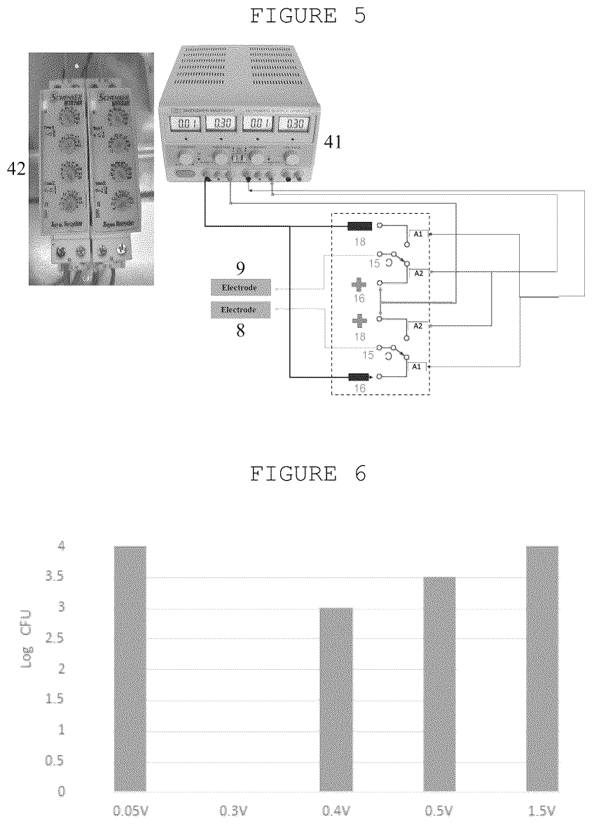

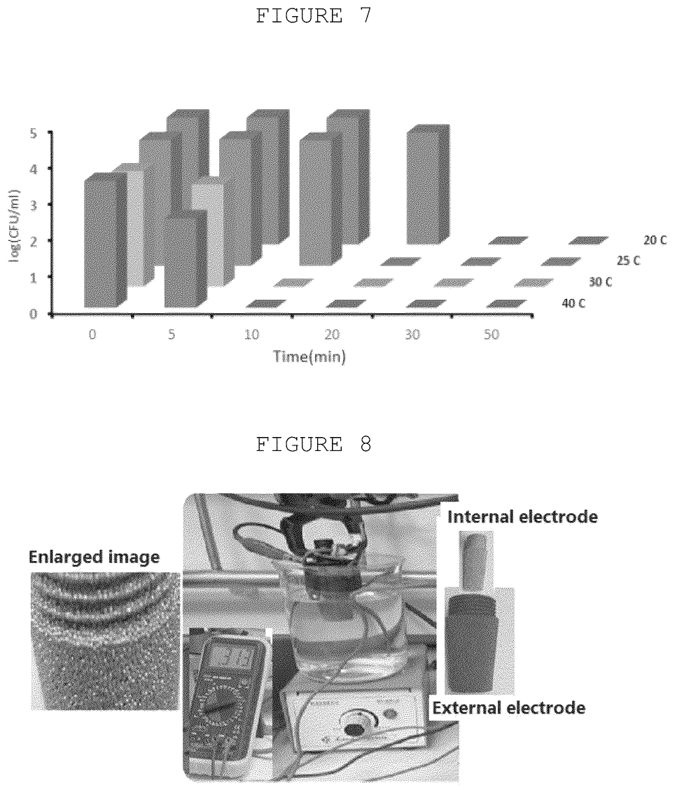

A device as depicted in FIG. 3 was operated with induced electric potential of 0.05V, 0.3V, 0.4V, 0.5V, and 1.5V. The electrodes were immersed in 1 L of water containing 1×10⁴/cm³ E. Coli. After treatment at different voltages, samples were plated on agar and the number of CFUs per ml was calculated. Results are summarized in FIG. 6, which is a histogram of Log CFU/ml of E. Coli bacteria as a function of potential difference in V. FIG. 6 illustrates that there is a narrow range of voltages that produces antibacterial activity. 0.3 V is the approximate midpoint of this range. It is believed that the antibacterial effect is due to production of monovalent copper ions as described above. FIG. 7 is a 3D histogram of Log CFU/ml of E. Coli bacteria as a function of time (min) and temperature (° C.). The results indicate that the lower the temperature the longer the time required to achieve effective disinfection of the water. At 20° C. effective disinfection required more than 20 minutes, but less than 30 minutes. At 30° C. and 40° C., effective disinfection required more than 5 minutes, but less than 10 minutes. This data demonstrates that the system is useful in swimming pools and spa facilities (heated pools).

### Example 2

Water Disinfection Using Nested, Sintered Bronze Electrodes in Cylindrical Configuration, with Voltage Applied Across the Electrodes and Addition of Cu²⁺ to the Water

A series of experiments was performed to study the antibacterial effect generated by the application of voltage (in the range of 0.05V to 1.5V) across bronze electrodes, in the presence of cupric ions, i.e., killing bacteria in water.

The experimental setup is shown in FIG. 8. A pair of sintered bronze electrodes (consisting of cylindrically-shaped, coaxially-positioned, outer and inner electrodes, 50 mm and 30 mm long, respectively) is immersed in the aqueous solution to be treated. The outer diameter of the outer electrode is 35 mm. The outer diameter of the inner electrode 15 mm. The electrodes are made of bronze grains (consisting of 93% copper and 7% tin). The grains are 50 microns in diameter, pressed into the cylindrical shapes with the dimensions set out above (cylindrically-shaped sintered bronze are commercially available from SATKIRTI FILTER TECHNOLOGIES PVT.LTD). The roughened surface morphology of the sintered bronze electrode is seen in the enlarged image. The electrodes were connected to a DC voltage source.

1 liter flask equipped with a magnetic stirrer was charged with 0.8 liter of an aqueous solution to be disinfected (the solution was contaminated with 1×10⁴ E. Coli bacteria/cm³). CuSO₄ was added to the solution, to supply Cu²⁺ ions at concentrations of 0.1, 0.2, 0.5 and 10 ppm. The bactericidal effect arising from the application of DC voltage of 0.05V, 0.1V, 0.2V, 0.3V, 0.4V and 1.5V for 30 min across the bronze electrodes, was determined for each concentration of the cupric ions.

After the thirty minutes test period, 0.1 ml sample was added to an agar plate to measure bacteria growth. The number of bacterial colonies developed on the agar plate was counted after incubation for twenty-four hours.

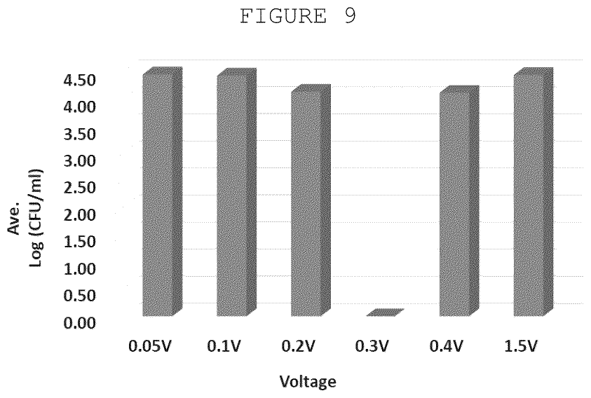

The results are shown in the form of a bar diagram (log CFU/ml versus voltage) in FIG. 9, for the set of experiments involving the presence of 0.2 ppm Cu²⁺. The results show that a very strong antibacterial effect was obtained within a narrow voltage window (˜0.3V), akin to the effect reported in Example 1. That is, almost eradication of the bacteria in water.

Water disinfection by the method described above was studied with variation of treatment temperature. The trend observed is like the one reported in Example 1, in reference to FIG. 7. That is, the efficiency of the method increases with increasing temperature. When the water temperature is from 30 to 40° C., it is possible to achieve strong bactericidal effect after a short treatment time. However, very good results are obtained also at a lower temperature, e.g., from 20 to 30° C.

### Example 3

Large Scale Experiment: Water Disinfection Using Nested, Sintered Bronze Electrodes in Cylindrical Configuration, with Voltage Applied Across the Electrodes and Addition of Cu²⁺ to the Water from IEX Placed Upstream to the Electrodes

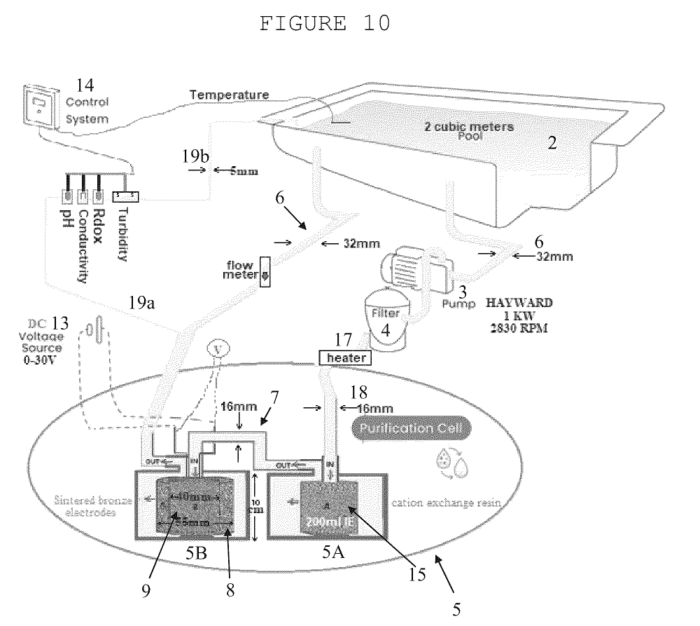

The experimental setup consisted of 2 cubic meter water tank (2), as shown in FIG. 10, equipped with a circulation line (6), provided by 32 mm diameter pipe. A pump (3) supplying flow rates of 200 to 750 liter/hour (Hayward 1 KW, 2830 rpm), a filter (4) and a heater (17) were placed along the circulation line (6). The disinfection system (5) was installed downstream to the heater (17) and was connected to the circulation line (6) by 16 mm diameter pipe (18); all piping mounted in the disinfection system was of that diameter.

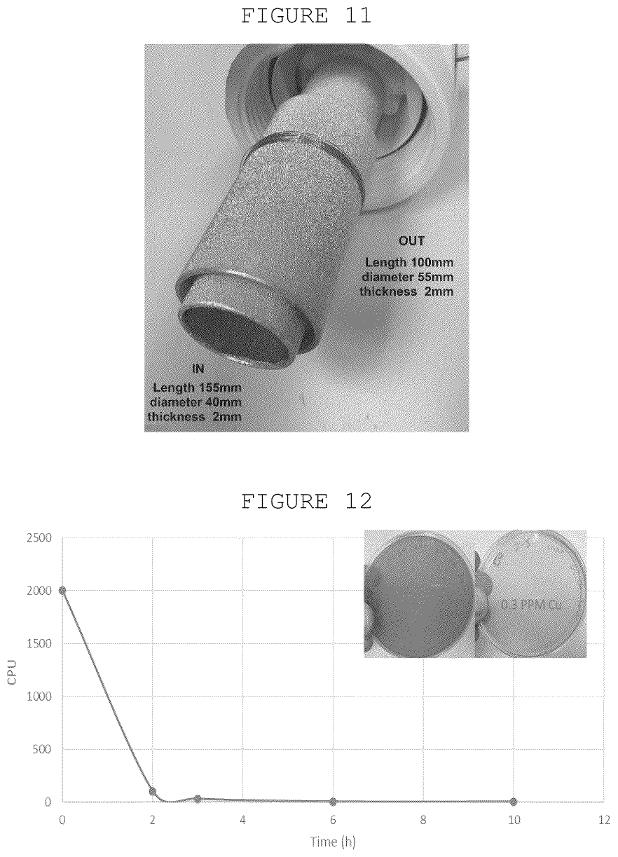

The disinfection system consisted of a first and second water filter housings (5A, 5B), to accommodate the IEX (15) and the electrodes (8,9), respectively. The first filter housing (a 10 cm long device) was filled with 200 ml of a cation exchange resin (aminophosphonic chelating resin) that was charged beforehand with cupric ions (30 mg/liter). The second filter housing (a 10 cm long device) was placed downstream to the IEX column. A pair of sintered bronze electrodes (consisting of cylindrically-shaped, coaxially-positioned, outer and inner electrodes 8,9) was installed in the second filter housing, as shown in the photograph appended in FIG. 11. The outer diameter of the outer electrode was 55 mm. The outer diameter of the inner electrode was 40 mm. The lengths were 155 mm and 100 mm, (inner and outer electrodes, respectively). Each electrode was 2 mm thick. The electrodes were made of bronze grains (consisting of 93% copper and 7% tin). The grains were 50 microns in diameter, pressed into the cylindrical shapes with the dimensions set out above (commercially available from SATKIRTI FILTER TECHNOLOGIES PVT.LTD). The roughness of the surface of the sintered bronze electrodes is clearly seen in the photograph of FIG. 11. The electrodes were connected to a DC voltage source (13).

The 16 mm diameter pipe (18) that directs the circulated water in line (6) to the disinfection system (5) is fitted into the first water filter housing (5A), filled with the IEX resin (15). The first (5A) and second (53) water filter housings are joined by a duct (7) with diameter of 16 mm, directing the water stream discharged from (5A) to the electrode assembly (8,9) in (53). The water is guided by duct (7) to flow into the interior space of the inner electrode (9).

A subsidiary water line (19a) of 5 mm diameter, diverged from the circulation line (6) to supply water to the control system (14) with a return line (19b) connected to the pool. pH electrode, redox electrode, conductivity meter, and turbidity meter were mounted in the control unit while temperature was measured with the aid of a thermoset immersed in the water tank (2). A flowmeter was installed in the circulation line (6) downstream to the disinfection system (5).

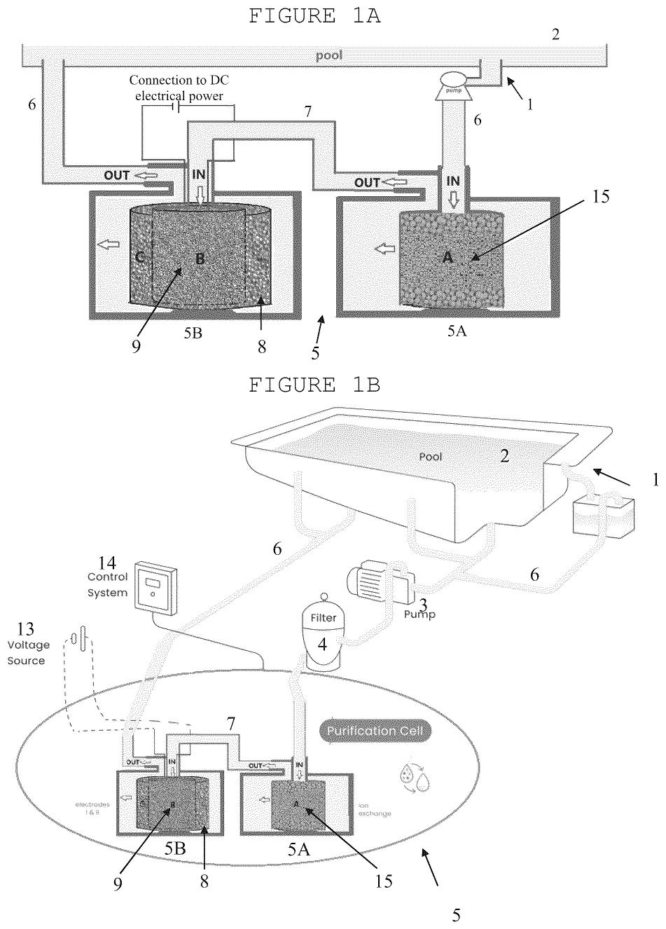

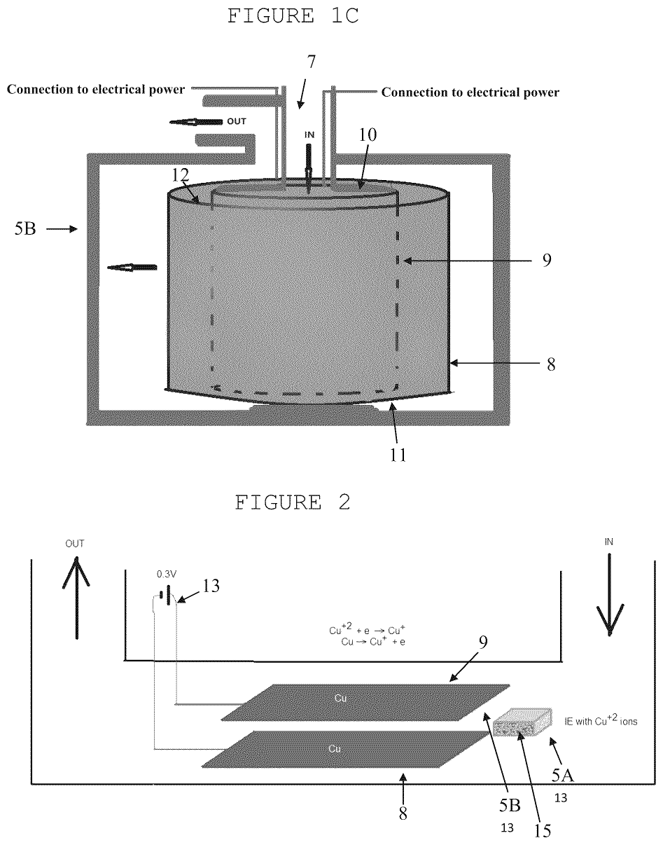

In operation, water flows in the circulation line (6), passing through the IEX (15) packed in the first filter housing (5A) and moves to the second filter housing (53), into the interior of the inner electrode (9). The water is impelled by the pump (3) to flow through the porosity of the wall defining the inner sintered bronze electrode (9) into an annular space located between the outer and inner electrodes (8,9; as was already explained in reference to FIG. 1C), returning to the water tank. All experiments were conducted under the application of constant DC voltage of 0.3V, with reversal of polarity taking place every ten minutes.

Process variables that were tested include A) type of bacteria added to the water; B) the water flow rate supplied by the pump (which determines the turnover rate), and C) the pH of the water.

Part A: Eradication of E. coli

E. coli was added to the water to reach an initial microbial load of 2000 CFU/ml. The concentration of Cu²⁺ supplied to water stream by the IEX was 0.2-0.3 ppm and the pH of the water was 7.4. Water was circulated at a flow rate of 250 liter/h over ten hours. The water was sampled periodically during the test period; the sample was added to an agar dish as explained above to determine the development of bacterial colonies. The results are shown in FIG. 12, as bacterial counts versus time plot. A strong antibacterial effect was achieved after two hours, with bacterial population dropping from 2000 to 100 bacteria per ml (˜ 1.3 log reduction). Complete bacteria eradication was observed after six hours of treatment, when the system reached “zero germs”. A photograph of the control and treatment petri dishes was inserted into the graph of FIG. 12 (left and right, respectively).

### Part B: Turnover Rates and Time Taken to Eradicate Bacteria

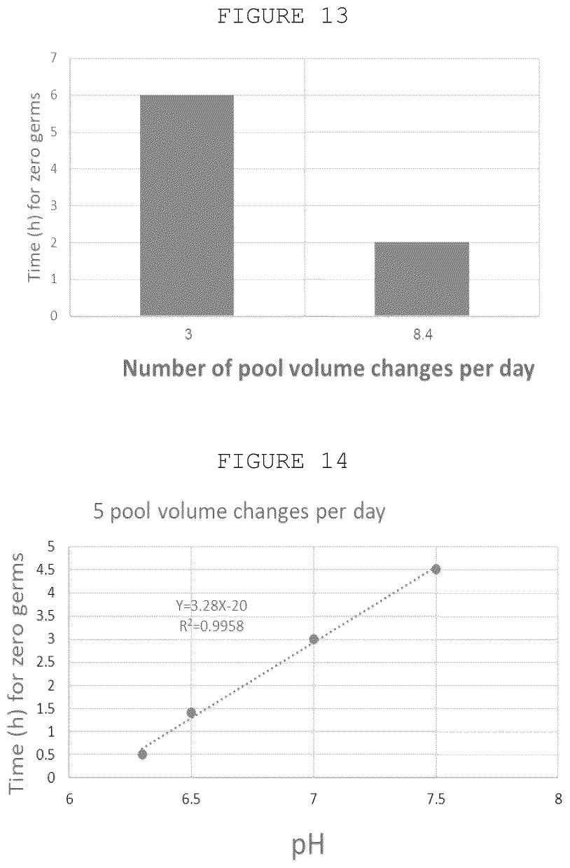

E. coli was added to the water to reach an initial microbial load of 2,000-20,000 CFU/ml. Water circulation at a flow rate of 250 liter/hour amounts to turnover rate of eight hours (the number of hours it takes for the total volume of water (2000 liter) to pass through the disinfection system consisting of the IEX and the electrodes; it can also be expressed as 3 tank volume per day (24 h/8 h=3). As shown above, with turnover rate of eight hours, six hours were needed to reach full bacteria eradication (“zero germs”). In another experiment (T=27° C., [Cu²⁺]=0.2-0.3 ppm, pH=7.4), the flow rate of the water circulated was increased to 700 liter/h (which amounts to turnover rate of 2.85 hours, or 8.4 tank volume per day (24 h/2.85 h-8.4). With reduction of turnover rate from 8 h to 2.85 h, the time needed to achieve full bacteria eradication (“zero germs”) was as low as two hours. The results are shown graphically in the form of a bar diagram in FIG. 13.

### Part C: pH and Time Taken to Eradicate Bacteria

E. coli was added to the water to reach an initial microbial load of 2,000-20,000 CFU/ml. The effect of the water pH on the treatment was studied, by determining the time taken to achieve full bacteria eradication (“zero germs”) with pH variation. A set of experiments was performed with T=27° C., [Cu²⁺]=0.2-0.3 ppm, turnover rate of 4.8 hours generated by flow rate of 416 liter/hour, and pH variation across a nearly neutral range from 6.3 to 7.5. The results are shown in FIG. 14, where t_{eradication} is plotted versus pH. A linear dependence on pH was found, the more acidic the solution, the more efficient the system. pH adjustment was made with 32% HCl solution.

### Part D: Water Circulation Over ˜ Four Months

The experimental setup was operated over almost four months [average T=27° C., average [Cu²⁺]˜0.3 ppm, average turnover rate of 4.5 hours generated by flow rate of 445 liter/hour]. Additional process variables were measured periodically (almost every day) and average results are tabulated in Table 2; it is seen that all measured values were within the respective acceptable range. For example, pH stabilized at 7.5-7.6.

TABLE 2

| | | Voltage | | | Redox |
|---|---|---|---|---|---|
| | | Across | | | potential |
| | | electrodes | Turbidity | Conductivity | (mV vs. |
| | pH | (V) | (NTU) | (mS) | Ag/AgCl) |
| Average | 7.52 | 0.29 | 0.94 | 0.68 | 316 |
| Acceptable | 6.5-7.8 | 0.25-0.38 | 0.8-1.1 | 0.5-1.5 | 280-350 |
| range | | | | | |

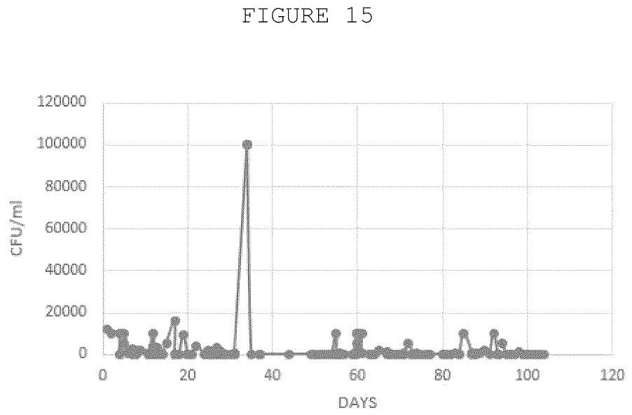

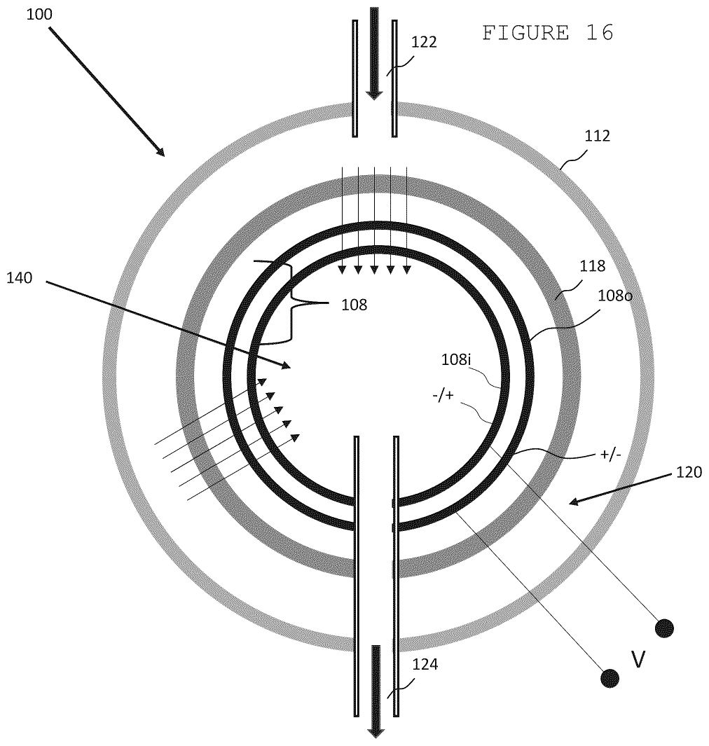

During the ˜ four months test period, water samples were collected occasionally, plated on agar samples and microbial load was counted (CFUs per ml). The results shown graphically in FIG. 15 (CFU/ml versus time) indicate the strong bactericidal effect achieved by the treatment, keeping low bacterial load in the water, over the entire test period. It is seen that from time to time the treatment was challenged by intentional addition of E. coli to the water (to create microbial load of few thousands of CFU/ml). The unusually high count (100000 CFU/ml) was due to very high addition of bacteria to the water at that day, to assess the ability of the system to encounter the occurrence of a sudden, serious contamination in the water.

In addition to the collection of samples almost on daily basis and the CFU/ml counts reported in FIG. 15, the effect of the treatment on other microorganisms was studied. On three occasions during the four months period, samples were collected and tested to determine levels of certain microorganism as tabulated in Table 3 (average of the three measurements).

TABLE 3

| Organism | Average Result | | Test method |
|---|---|---|---|
| Legionella | <100 | CFU/liter | ISO 11731-2: 2017 (E) |
| Coliform bacteria | <1 | CFU/100 mL | SM 9222B |
| Escherichia coli | <1 | CFU/100 mL | SM 9222G |
| Pseudomonas aeruginosa | <1 | CFU/100 mL | SM 9213E |
| Staphylococcus aureus | <1 | CFU/100 mL | SM 9213B |

The results attest to the utility of the invention, i.e., efficient control of microbial growth in water.

### Example 4

Disinfection of different types of microorganism (bacteria, fungi) The experimental setup consisted of 100 ml flask, in which a pair of planar electrodes made of sintered bronze were immersed in the water, spaced 1 cm apart. The composition of the bronze alloy was 93% copper and 7% tin. The sintered bronze electrodes are composed of 50 μm pressed grains, showing highly roughened surface morphology. The electrodes were identical in shape and size (in the form of a sector of a semicircle (diameter=50 mm), bound by the arc, the diameter and a 25 mm long straight line perpendicular to the diameter; the bronze electrode is 2 mm thick). Water samples (100 ml) were contaminated with the tested microorganism, at initial microbial load of 2000 CFU/ml. Cu² was added to the water by dissolving CuSO₄ to get ˜1 or 2 ppm of the cupric ion in the water. The electrodes were connected to a DC voltage source that supplied potential difference of 0.3 V across the electrodes. Water temperature was 30° C. (the flask was placed in a water bath).

The following microorganisms were killed by the treatment (usually within thirty minutes of application of the voltage across the electrodes, in the presence of cupric ions in the water): Escherichia coli, Staphylococcus aureus, Bacillus thuringiensis, Enterobacteraerogenes, Micrococcus luteus, Staphylococcus epidermidis, Streptococcus faecalis, Pseudomonas aeruginosa, Delftiatsuruhatensis, Staphylococcus cohnii, Brevibacillusbrevi, Cyanobacteria, Brewer's yeast, Baking yeast. Gram negative bacteria were found to be more susceptible to the bactericidal effect generated by the invention: high removal rates were achieved after relatively short period of time compared to gram positive bacteria.

### Example 5

### Examples 5A-5D (of the Invention) and 5E-5G (Comparative)

### Testing the Effects of Electrode Material and Morphology and Presence of Cu²⁺ Ions on the Efficacy of the Treatment

The experimental setup consisted of 100 ml flask, in which a pair of rectangular flat electrodes (length: 30 mm; width: 10 mm; thickness: 2 mm) were immersed in the water, spaced 1 cm apart. The water was contaminated with E. coli, at initial microbial load of 1000 CFU/ml. Cu²⁴ was added to the water by dissolving CuSO₄ to get 2 ppm of the cupric ion in the water. The electrodes were connected to a DC voltage source that supplied potential difference of 0.3 V across the electrodes. Water temperature was 30° C. The type of electrode tested, presence/absence of Cu²⁺, and the time taken to achieve 1 log reduction (90% reduction) are tabulated in Table 4.

TABLE 4

| | | Initial | | |
|---|---|---|---|---|
| | Electrode | [Cu²⁺] | Time taken to get | |
| Ex. | (material, morphology) | ppm | 1 log reduction | |
| 5A | Pure copper, smooth | 1 | 180 | min |
| 5B | Copper, foam | 1 | 30 | min |
| 5C | Bronze (Cu—Sn: 93-7), smooth | 1 | 20 | min |
| 5D | Bronze (Cu—Sn: 93-7), sintered | 1 | 5 | min |

| | | | |
|---|---|---|---|
| | (pressed 50 μm grains) | | |
| 5E | Titanium | 1 | no killing of E. coli |
| | | | (after 300 min) |
| 5F | none | 1 | no killing of E. coli |
| | | | (after 300 min) |
| 5G | Pure copper | 0 | no killing of E. coli |
| | | | (after 300 min) |

### Example 6

### A Continuous System Designed for Disinfecting Contaminated Water (Wastewater, Gray Water, Drinking Water)

The experimental setup was based on the design shown in FIGS. 4A and 4B. It consisted of two sections of a pipe with a diameter of 10 cm. Four electrodes were supported on a water impermeable circular plate fitted in the boundary between the two sections of the pipe, such that the plate occupied the cross section of the pipes. Each electrode was built of two identical parts; each part was made of porous sintered bronze shaped as a hollow frustrum (see in FIG. 8, labeled “internal electrode”). The cavities of the frusta were filled with resin, and the two resin-filled parts were connected with an electric conductor therebetween. The electrodes, containing the resin in their interior, protruded symmetrically from the opposing faces of the plate. The four electrodes were connected to DC power supply, in a way that two neighboring electrodes are of opposite polarity (Electric wires charge each neighboring electrode so that the potential between them is 0.3 volts).

The contaminated water flows from the first pipe through the electrically charged electrodes (through the electrode porosity) to the second pipe. Contaminated water (10⁴ per ml E. coli) with flow rate of 10 l/h was completely disinfected when passing through the system.

FIG. 16 schematically illustrates a cross-section of a unified, cylindrically shaped disinfecting apparatus 100, according to a second embodiment of the invention. Three layers are coaxially contained within the apparatus, as follows: (a) a Cu²⁺-loaded cation exchange resin 118 layer (in granular form), which enriches the water with Cu²⁺ ions; (b) outer porous-made copper-containing electrode 108o and inner porous-made copper-containing electrode 108i layers. The pair of outer and inner copper-made electrodes, 108o and 108i, forms an electrodes' unit that converts the water enrichment from Cu²⁺ ions to water enriched with Cu⁺ ions. Water coming from the pool enters the inlet compartment 120 via inlet pipe 122. The water passes through the Cu²⁺-loaded cation exchange resin 118 layer and then through the pair (outer and inner) of copper-containing electrodes 108, entering the outlet compartment 140 as Cu⁺ enriched water. The water enriched with Cu⁺ ions leaves from outlet compartment 140 of the apparatus via outlet pipe 124 and circulates back to the pool. In consistency with the previous description above, a low DC voltage supply V is provided to the two electrodes 108i and 108o, respectively, to form a potential difference of less than 0.5 V, e.g., from 0.1 to 0.5V, from 0.15 to 0.45V, from 0.2 to 0.4 V, or from 0.25 to 0.37 V. The polarity of the DC voltage may alter periodically, for example, every 1-20 minutes. System 100 includes additional components, such as a pump, a water filter, a control unit, and additional pipes, as described above for FIGS. 1A-1C mutatis mutandis.

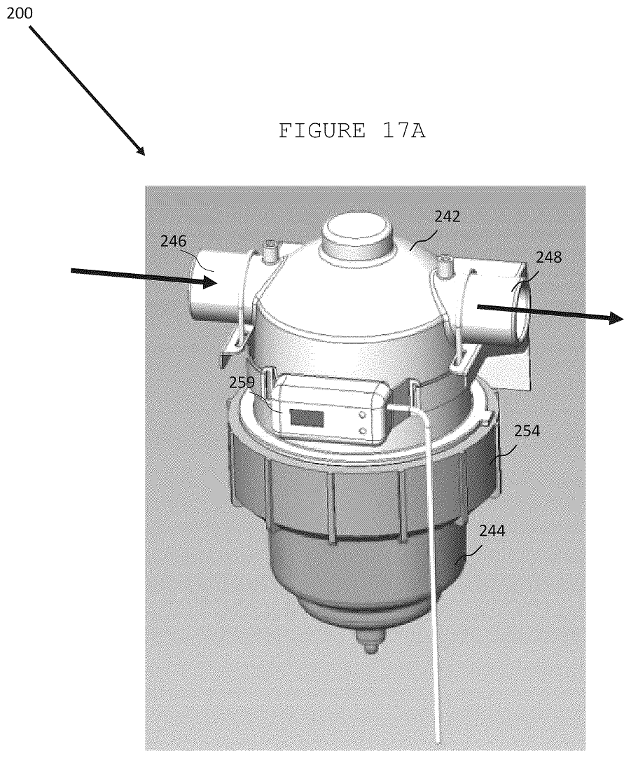

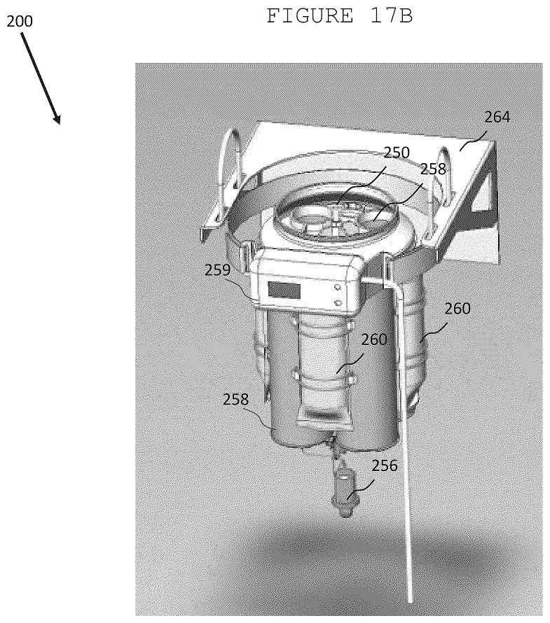

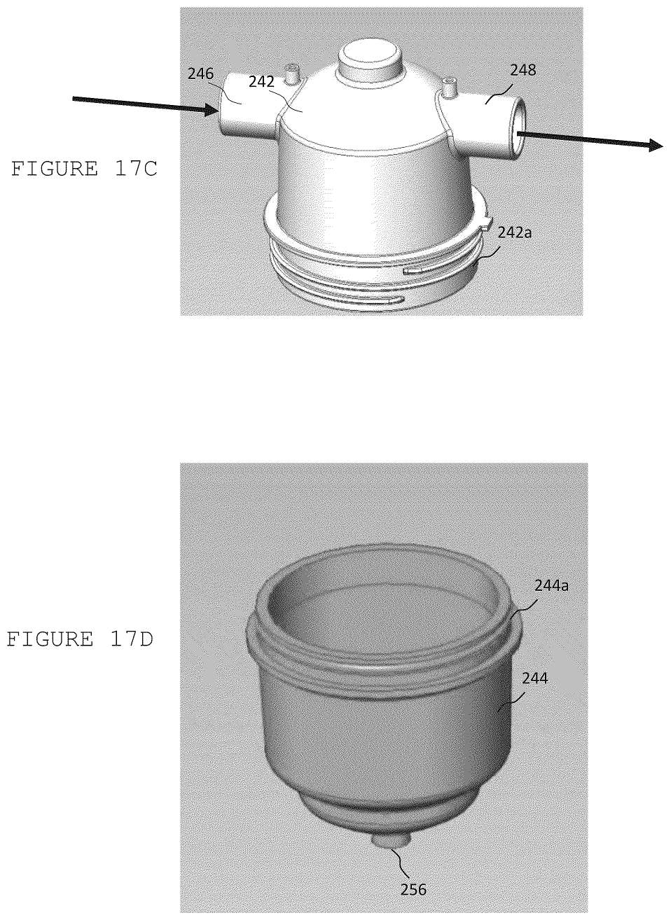

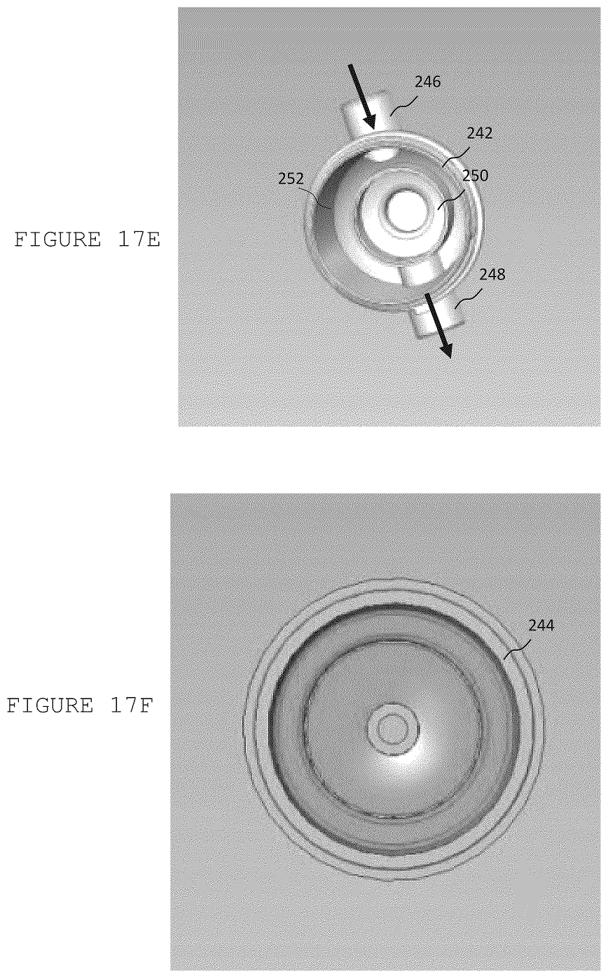

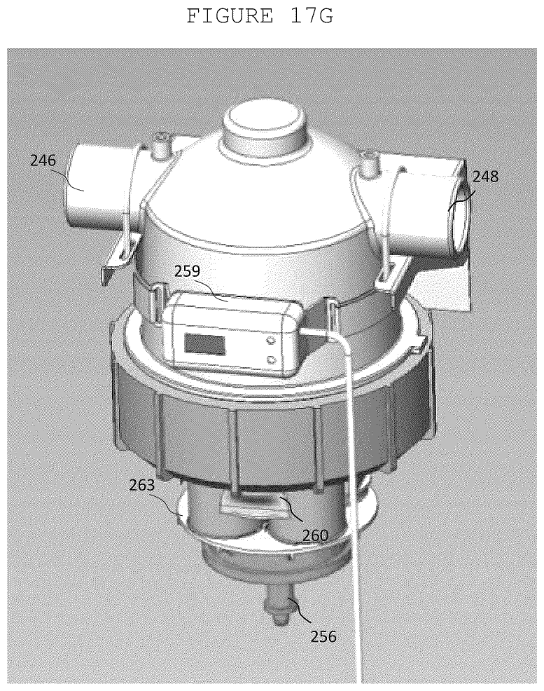

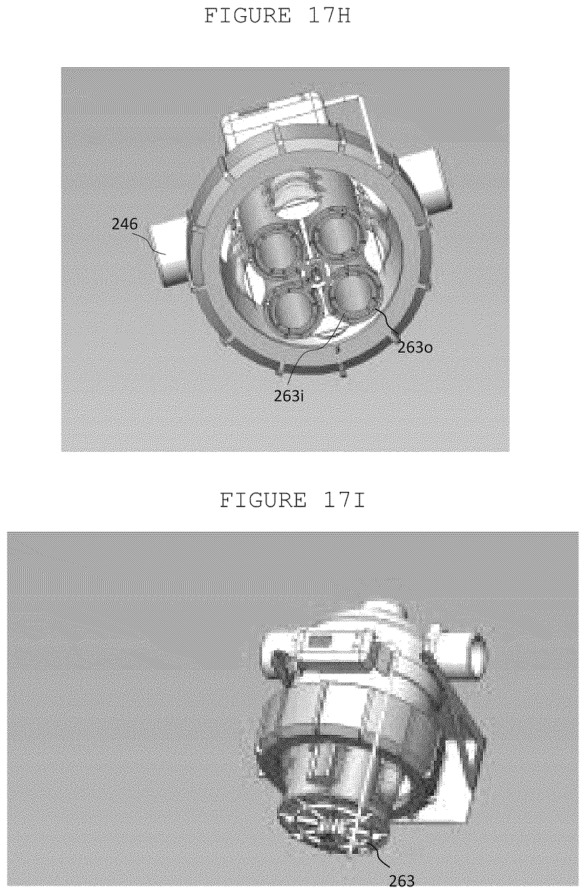

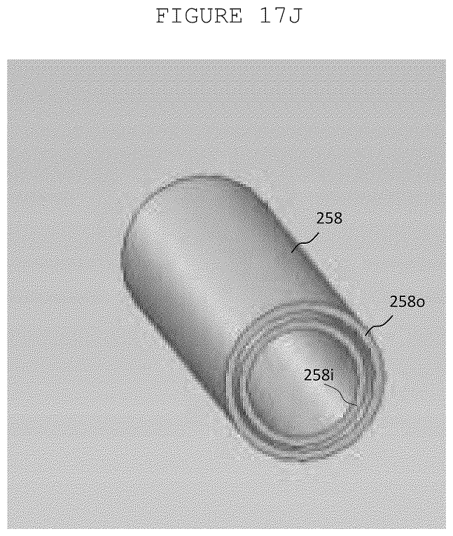

FIGS. 17A-17J illustrate an apparatus 200 that includes four electrodes' units 258, and four Cu²⁺-loaded cation exchange units 260 (hereinafter, “cation exchange units”)—all contained within a single sealed casing. In this specific case, the sealed casing includes a bottom portion 244 and a top portion 242, sealed together utilizing respective threads 244a and 242a, respectively (and connector 254). Each cation exchange unit 260 contains material in the form of spherical beads (granular form) as described above, packed within a perforated pouch. Each electrodes unit 258 includes two coaxial, spaced apart, copper-alloy outer and inner electrodes, 258o and 258i, respectively (see FIG. 17J). As shown in FIG. 17B, the four pair of electrodes (four units) are peripherally disposed about an axial pole (not shown), where each cation exchange unit 260 is placed, for example, in the outer cavity formed between each pair of electrodes' units 258. Water coming from the pool enters an inlet compartment 252 of the apparatus via the inlet pipe 246 (see FIG. 17E). The inlet compartment is defined by the space formed between the inner wall of the sealed casing and the outer facets of both a cation exchange unit 260 and an electrodes' unit 258. There is no necessity for the whole capacity of the water to penetrate both a cation exchange unit 260 and an electrodes unit 258 to sufficiently enrich the water by Cu, therefore, a partial peripheral coverage, as shown, for example, in FIG. 17B is sufficient. When passing through the electrodes' unit 258, the Cu²⁺ enriched water is converted to Cu⁺ enriched water, capable of eliminating germs from the pool's water. After the passage through the electrodes' unit, the CU⁺ enriched water arrives at outlet compartment 250, and from the outlet compartment, the water is conveyed to the pool via outlet pipe 248. The apparatus is so arranged that water can arrive at the outlet compartment 250 only after passing through at least one electrodes unit 258. At least some water passes through both the cation exchange unit 260 and the electrodes unit 258 to obtain the effect of the invention.

The DC voltage (typically 0.2V-0.5V, e.g., 0.2-0.4V preferably 0.3V) is supplied from the control unit 259 (FIG. 17B) through connector 256 (and additional wiring) towards the voltage distributor 263 (FIGS. 17G and 17I), which distributes respective voltage polarities to all the electrodes. The voltage distributor may have the form of a printed circuit that supplies the voltage to each specific electrode via outer and inner voltage adapters 2631 and 263o (FIG. 17H), respectively. The following voltage supply regime is preferably maintained: (a) the (+) and (−) voltage polarities are conveyed to the inner and outer electrodes within the same electrodes' unit; (b) Within two adjacent electrodes' units—when the outer electrode of the first unit in the pair receives a (+) polarity, the outer electrode of the second adjacent unit receives as (−) polarity—this form increases the effect and rate of the ion conversion (from Cu²⁺ to Cu⁺); and (c) The polarity provided to each electrode (258o, 258i) is alternated by the control unit 258 every specific T period, for example, 1-20 minutes. This alteration also increases the rate of ion conversion.

The control unit 258 may include a display showing the voltage V supplied to the electrodes, and possibly also the current (as shown in FIG. 17B).

It should also be noted that preferably all the electrodes' units 258 and the cation exchange unit are maintained substantially vertically during the apparatus operation. Moreover, a single full periphery unit 260 may be used instead of a plurality of cation exchange units. Similarly, a single electrodes' unit (a single pair) 258 may be used rather than the four shown. Moreover, any number of electrodes' units may be used. An increase in the number of electrodes' units 258 increases the surface area that is exposed to water and, therefore, also the efficiency of the apparatus. Typically, the distance between the outer electrode 258o and the inner electrode 258i within the same unit 258 may range between 1 mm to 20 mm (4 mm have been used by the inventors). The porous size within each of the electrodes may range, for example, between 20 μm and 400 μm (the inventors have used 200 μm).

### Experiment 1

An apparatus, as in FIG. 17A-17J, was used to disinfect a swimming pool of 20 m³. The apparatus included four porous (200 μm) electrodes' (alloys made of 93% Cu, and 7% Sn) units having a height of 175 mm. The outer diameter of the outer electrode was 54 mm. The inner diameter of the outer electrode was 48 mm. The outer diameter of each inner electrode was 44 mm and the inner diameter of the inner electrode was 38 mm. The weight of the inner welectrode was 350 gr. The weight of each outer welectrode was 386 gr. The distance between the electrodes within each unit was maintained stable by a plastic structure in both ends of the electrodes. Four pouches 260, each containing 200 gr of cation exchange (amino-phosphate). Water was circulated through the apparatus at a rate of 4 m³/hr. Contamination in the amount of 2000-100,000 bacteria/ml was added to the water (Escherichia coli) and the contamination level was measured at a period every 10 minutes. After 30 minutes, it was discovered that the contamination was reduced to zero. The copper ions concentration within the water pool was 0.15-0.3 ppm. The pH reached to 7.5 and remained stable. The water temperature ranged between 20 to 35 degrees Celsius.

### Experiment 2

An apparatus, as in FIG. 17A-17J, was used to disinfect a swimming pool of 80 m³. The apparatus included four porous (200 μm) electrodes' (alloys made of 93% Cu, and 7% Sn) units having a height of 175 mm. The outer diameter of the outer electrode was 54 mm. The inner diameter of the outer electrode was 48 mm. The outer diameter of each inner electrode was 44 mm and the inner diameter of the inner electrode was 38 mm. The weight of the inner electrode was 350 gr. The weight of each outer welectrode was 386 gr. The distance between the electrodes within each unit was maintained stable by a plastic structure (in both ends of the electrodes. Four pouches 260, each containing 200 gr of cation exchange (amino-phosphate). Water was circulated through the apparatus at a rate of 12 m³/hr. The pool was regularly used by 3-5 persons (on the average about 3 hrs a day). The contamination level was measured weekly during 6 months. All the measurements showed zero bacteria. The copper ions concentration within the water pool was 0.15-0.3 ppm. The pH reached to 7.5 and remained stable. The water temperature ranged between 20 to 35 degrees Celsius.

1. A method of water disinfection, comprising adding nonindigenous Cu²⁺ ions to the water and applying voltage across copper-containing electrodes in contact with the water to generate an antimicrobial effect.

2. The method according to claim 1, wherein the voltage applied is from 0.2 to 0.4 V.

3. The method according to claim 1, wherein the nonindigenous Cu²⁺ ions am supplied to the water from a cation exchange resin charged beforehand with Cu²⁺ ions.

4. The method according to claim 3, wherein the cation exchange resin is a chelate resin with functional groups that contain nitrogen and/or oxygen and/or sulfur atoms.

5. The method according to claim 4, wherein the functional groups of the chelate resin can form a coordination complex with Cu²⁺, with selectively higher compared to Ca²⁺.

6. The method according to claim 4, wherein the functional group linked to the chelate resin is aminophosphonic acid group.

7. The method according to claim 1, wherein at least one copper-containing electrode is a sintered Cu—Sn (bonze) electrode.

8. The method according to claim 1, wherein at least one electrode is cylindrically shaped.

9. The method according to claim 8, wherein a pair of copper-containing electrodes are assembled as nested electrodes with cylindrical configuration, consisting of an outer electrode comprising a lateral surface of a cylinder, encircling an inner electrode in the form of wire, rod, or a hollow tube.

10. The method according to claim 9, comprising impelling water by a pump to flow in a water supply line or in water circulation line connected to a packed bed of Cu²⁺-loaded ion exchange resin positioned upstream to the electrodes assembly, such that Cu²⁺-added water released from the ion exchange resin moves to, and passes through, an annular space located between the outer and inner electrodes.

11. The method according to claim 9, comprising impelling water by a pump to flow in a water supply line or in water circulation line connected to a packed bed of Cu²⁺-loaded ion exchange resin positioned upstream to the electrodes assembly, wherein the electrodes assembly consists of an outer electrode in the form of a lateral surface of a cylinder encircling an inner electrode in the form of a hollow tube, wherein the electrodes are made of sintered Cu—Sn, wherein the electrodes assembly has a front side for receiving an incoming water stream and a rear side, wherein the rear side of the electrodes assembly is optionally sealed, such that Cu²⁺-added water released from the ion exchange resin moves to the interior of the inner electrode and flows through the porosity of the wall of the inner electrode into an annular space located between the outer and inner electrodes, and from the annular space, to the water supply line or the water circulation line.

12. The method according to claim 9, wherein the electrodes assembly consists of an outer electrode is in the form of a lateral surface of a cylinder encircling an inner electrode in the form of a hollow tube, wherein the inner electrode is made of sintered Cu—Sn, wherein the electrodes assembly has a front side for receiving an incoming water stream and a rear side, wherein the rear side of the electrodes assembly is optionally sealed, with the ion exchange resin filing the interior of the inner electrode, wherein the method comprises impelling water by a pump to flow in a water supply line or in water circulation and move into the interior of the inner electrode, such that Cu²⁺-added water released from the ion exchange resin flows from the interior space of the inner electrode through the porosity of the wall of the inner electrode into an annular space located between the outer and inner electrodes, and from the annular space to the water supply line or the water circulation line.

13. The method according to claim 8, comprising impelling water to flow through 2n cylindrically-shaped sintered Cu—Sn electrodes, with n electrodes connected to the positive pole of a DC power source and n electrodes connected to the negative pole of DC power source, wherein n is an integer number, with ion exchange resin filling the interior of at least n electrodes.

14. The method according to claim 1, wherein the water temperature is above 20° C.

15. The method according to claim 1, comprising generating cuprous (Cu⁺) ions in the water.

16. A disinfection system installable in a body of water, a water supply line or in a circulation line of a water flow, for reducing microbial load of the water, wherein the disinfection system has an inlet and an outlet for a water flow, said disinfection system comprising a packed bag of Cu²⁺-loadable cation exchange resin and copper-containing electrodes electrically connected to a DC power supply, and optionally a control unit comprising one or more of pH electrode, redox electrode, conductivity meter, turbidity meter and temperature meter.

17. The disinfection system according to claim 16, wherein the Cu²⁺-loadable cation exchange resin is a chelate resin with functional groups that contain nitrogen and/or oxygen and/or sulfur atoms.

18. The disinfection system according to claim 17, wherein the functional groups of the chelate resin can form coordination complex with Cu²⁺, with selectively higher compared to Ca²⁺.

19. The disinfection system according to claim 17, wherein the functional group linked to the chelate resin is an aminophosphonic acid group.

20. The disinfection system according to claim 16, wherein at least one of the copper-containing electrodes is a sintered Cu—Sn (bronze) electrode.

21. The disinfection system according to claim 16, wherein at least one of the electrodes is cylindrically shaped.

22. The disinfection system according to claim 16, wherein the copper-containing electrodes am assembled as nested electrodes with cylindrical configuration, consisting of an outer electrode comprising a lateral surface of a cylinder, encircling an inner electrode in the form of wire, rod, or a hollow tube.

23. The disinfection system according to claim 16, comprising a first subunit and a second subunit, with the packed bag of Cu²⁺-loadable cation exchange resin positioned in the rust subunit and the copper-containing electrodes in the second subunit, wherein the subunits am joined to allow water flow such that on installation in a water supply line or in circulation line of a water flow, the first subunit is installed upstream to the second subunit.

24. The disinfection system according to claim 22, wherein the copper-containing electrodes are sintered bronze electrodes assembled with cylindrical configuration, consisting of an outer electrode provided by a lateral surface of a cylinder encircling an inner electrode in the form of a hollow tube, with an annular space located between the electrodes, wherein the electrodes assembly has a front side facing the first subunit and an opposite mar side, wherein the rear side of the electrodes assembly is optionally sealed, such that on installation, water stream that exits the first subunit is directed to flow into the second subunit to enter the interior of the inner electrode, and wherein the water outlet opening of the disinfection system is in fluid communication with the annular space located between the electrodes.

25. The disinfection system according to claim 16, wherein the copper-containing electrodes are sintered bronze electrodes assembled with cylindrical configuration, consisting of an outer electrode provided by a lateral surface of a cylinder encircling an inner electrode in the form of a hollow tube, with an annular space located between the electrodes, wherein the electrodes assembly has a front side facing the water inlet opening of the disinfection system and an opposite rear side, wherein the rear side of the electrodes assembly is optionally sealed, with the ion exchange resin occupying the interior of said inner electrode.

26. The disinfection system according to claim 21, comprising 2n cylindrically-shaped sintered Cu—Sn electrodes, with n electrodes connected to the positive pole of a DC power source and n electrodes connected to the negative pole of DC power source, wherein n is an integer number, with ion exchange resin filling the interior of at least n electrodes.

27. The disinfection system according to claim 16, wherein the copper-containing electrodes are made of sintered copper-tin alloy, with 85-95% by weight Cu and 5-15% by weight Sn.

28. The disinfection system of claim 16, arranged in a coaxial multi-layer form, and comprising:
an inlet water compartment and an outlet water compartment;
a Cu²⁺-loadable cation exchange resin layer being in contact with water within the inlet compartment;
a copper containing perforated electrodes layer comprising first and second spaced apart and coaxial electrodes, where water that was at least partly subjected to contact with said Cu²⁺-loadable cation exchange resin layer, passes through said first electrode, then through the space between said two electrodes, and then through said second electrode towards said outlet compartment;
and wherein said DC power supply supplies voltage in a range of between 02-0.5 V.

29. The system of claim 28, wherein said Cu²⁺-loadable cation exchange resin layer comprising a plurality of resin-contained pouches.

30. The system of claim 29, wherein said copper containing perforated electrodes layer comprising a plurality of electrodes units, each said unit comprising said spaced-apart first and second electrodes.

31. The system of claim 29, wherein each said resin-contained pouch is positioned in a space formed between peripheries of adjacent pairs of said rust electrodes.

32. The system of claim 28, further comprising an inlet pipe leading contaminated water into said inlet compartment, and an outlet pipe leading disinfected water out of said outlet compartment.

33. The system of claim 28, further comprising a display showing the voltage supply into said electrodes layer, and/or current flowing through said electrodes layer.
